(19) United States
(12) Patent Application Publication
(10) Pub. No.: US 2008/0049968 A1
(43) Pub. Date: Feb. 28, 2008

(54) Methods, systems and computer program products for tagging media files to create records of distribution

(75) Inventors: Robert Koch, Norcross, GA (US); Dale Malik, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/509,518

(22) Filed: Aug. 24, 2006

(51) Int. Cl. G06K 9/00; H04N 5/76

(52) U.S. Cl. 382/100; 348/231.2

(57) ABSTRACT

Methods, systems and computer program products for tracking distribution of digital photographs are provided. Two or more digital photographs are obtained with a digital camera device. Distribution tags are associated with ones of the at least two digital photographs. The distribution tags include a distribution history for the at least two digital photographs.

### FIELD OF THE INVENTION

The present invention generally relates to digital media devices and, more particularly, to media files acquired by digital media devices and related methods and computer program products.

### BACKGROUND OF THE INVENTION

As photographs taken with film cameras (or traditional cameras) take a back seat to digital photographs, due to cost, convenience and the like, the use of photo albums and photo boxes that chronologically display photos related to particular events, for example, graduations, birthdays and the like, may become a thing of the past. Digital photographs may be more convenient than traditional photographs because, for example, traditional photographs cannot typically be stored in computer files or emailed to others without first scanning them into the computer. However, conventional digital camera devices store photographs taken with the camera linearly and, therefore, may be hard to organize and/or keep track of when stored on, for example, the digital camera device or a communications device.

### SUMMARY OF THE INVENTION

Some embodiments of the present invention provide methods for tracking distribution of digital photographs. Two or more digital photographs are obtained with a digital camera device. Distribution tags are associated with ones of the at least two digital photographs. The distribution tags include a distribution history for the at least two digital photographs.

In further embodiments of the present invention, information provided by the distribution tags may include who the associated digital photograph was distributed to, when the associated digital photograph was distributed, who printed the associated digital photograph, when the associated digital photograph was printed and/or content of the digital photograph.

In still further embodiments of the present invention, the content of the digital photograph may be provided by an event tag associated with the digital photograph. The event tag may identify a category for the photograph. The information provided by the distribution tag may further include information associated with other photographs associated with a same event tag.

In some embodiments of the present invention, a recipient of the two or more digital photographs may be alerted of the availability of more digital photographs associated with a same event tag.

In further embodiments of the present invention, the at least two digital photographs may be organized based on the information provided by the distribution tags. In certain embodiments of the present invention, a previous distribution may be recreated based on the information provided by the distribution tags.

Although embodiments of the present invention are discussed herein with respect to method embodiments, related digital camera devices and computer program products are also provided.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE FIGURES

Other features of the present invention will be more readily understood from the following detailed description of exemplary embodiments thereof when read in conjunction with the accompanying drawings, in which:

FIG. 1 is a block diagram of a data processing system suitable for use in devices according to some embodiments of the present invention.

FIG. 2 is a more detailed block diagram of data processing systems according to some embodiments of the present invention.

FIG. 3 is a high level block diagram illustrating a system according to some embodiments of the present invention.

FIG. 4 is a block diagram illustrating exemplary stored photographs according to some embodiments of the present invention.

FIG. 5 is a diagram illustrating exemplary contents of distribution tags according to some embodiments of the present invention.

FIG. 6 is a diagram illustrating an exemplary communication of digital photographs including distribution tags according to some embodiments of the present invention.

FIGS. 7 and 8 are flowcharts illustrating operations for tracking distribution of digital photographs according to various embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or flowchart illustrations of devices, methods and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

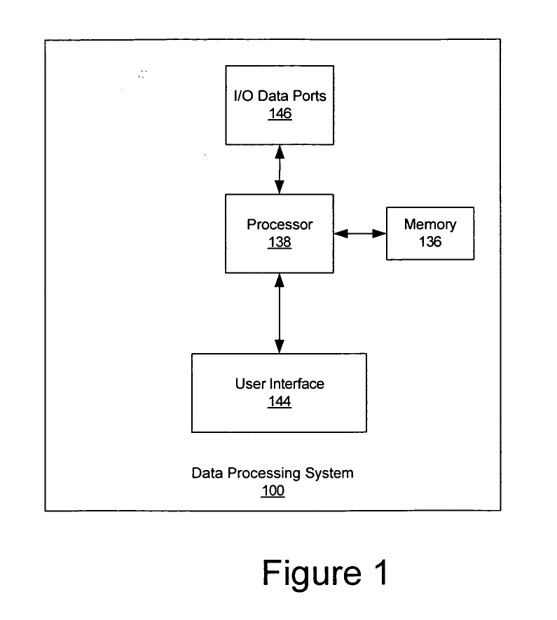

The use of digital media device, for example, digital camera devices, has become commonplace. Organizing digital media files, such as, photographs, may not be as easy as sorting and organizing traditional film photographs. Therefore, systems, methods and computer program products for tracking distribution of digital media files are provided according to some embodiments of the present invention. In particular, two or more digital media files or digital photographs may be obtained with a digital media device or digital camera device. Distribution tags may be associated with ones of the two or more digital photographs. The distribution tags include a distribution history for the two or more digital photographs. For example, the distribution tag may indicate when a digital photograph was sent via email and who it was sent to. Thus, according to some embodiments of the present invention, the distribution of digital photographs may tracked each time something is done with the photograph as will be discussed further herein with respect to FIGS. 1 through 8.

Although embodiments of the present invention are substantially discussed herein with respect to digital camera devices, embodiments of the present invention are not limited to this configuration. For example, embodiments of the present invention may used in combination with any type of media files which lend themselves to the teachings discussed herein without departing from the scope of the present invention.

As used herein, “digital camera device” refers to any device capable of taking digital or electronic photographs. For example, digital camera devices as used herein are not limited to camera devices. The digital camera device function may be included in another device, such as a portable electronic device or mobile terminal, without departing from the scope of the present invention.

As used herein, a “mobile terminal” includes both devices having only a wireless signal receiver without transmit abilities and devices having both receive and transmit hardware capable of two-way communication over a two-way communication link. Such devices may include cellular or other communications devices with or without a multi-line display; Personal Communications System (PCS) terminals that may combine a voice and data processing, facsimile and/or data communications capabilities; Personal Digital Assistants (PDA) that can include a radio frequency receiver and a pager, Internet/Intranet access, Web browser, organizer and/or calendar; and/or conventional laptop and/or palmtop computers or other appliances, which include a radio frequency receiver. As used herein, “mobile terminals” may be portable, transportable, installed in a vehicle (aeronautical, maritime, or land-based), or situated and/or configured to operate locally and/or in a distributed fashion at any other location(s) on earth and/or in space.

Details of various embodiments of the present invention will be discussed below with respect to FIGS. 1 through 8. Referring first to FIG. 1, an exemplary embodiment of a data processing system 100 suitable for use in a digital media device in accordance with some embodiments of the present invention will be discussed. The data processing system 100 typically includes a user interface 144, such as a keyboard, keypad, touchpad or the like, I/O data ports 146 and a memory 136 that communicate with a processor 138. The I/O data ports 146 can be used to transfer information between the data processing system 100 and another computer system or a network. These components may be conventional components, such as those used in many conventional data processing systems, which may be configured to operate as described herein.

As used herein, a “distribution tag” refers to a tag associated with a media file or photograph that provides historical information about the distribution and/or production of the media file/photograph or group of media files/photographs. For example, the distribution tag may indicate that photographs 1 and 3 out of 3 were emailed on Jun. 10, 2006 and that photograph 2 was printed five times as discussed further below with respect to FIGS. 1 through 8.

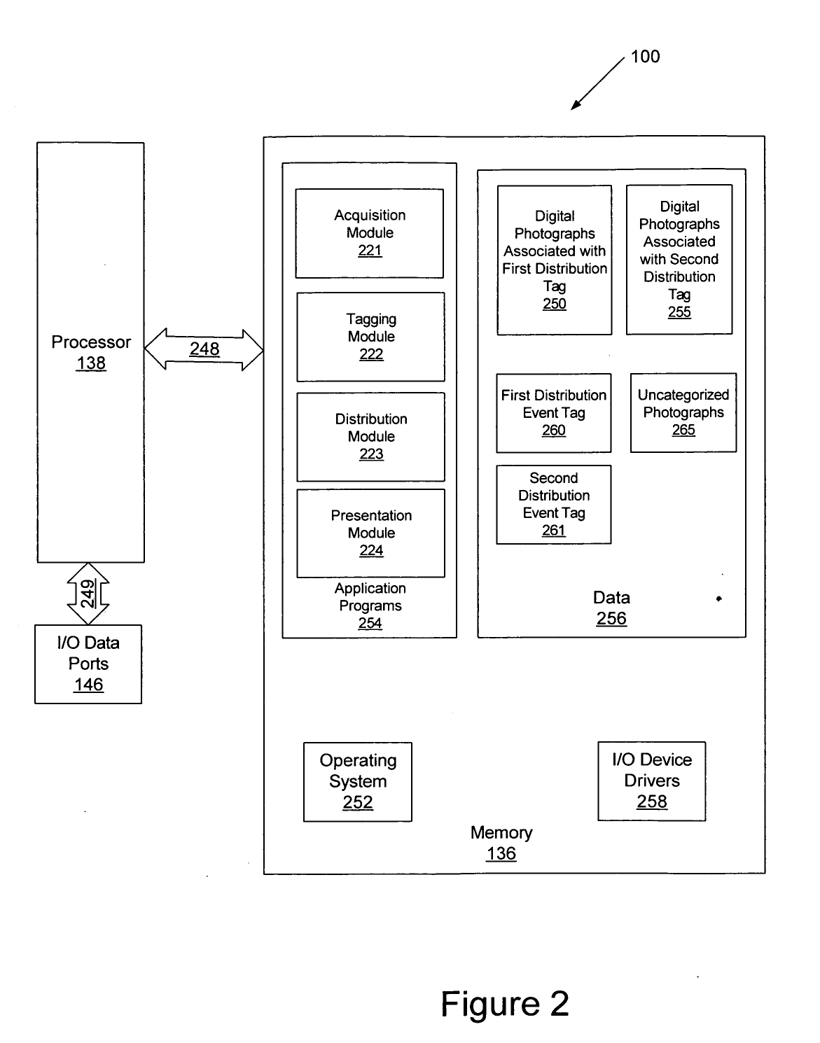

Referring now to FIG. 2, a more detailed block diagram of the data processing system 100 in accordance with some embodiments of the present invention will be discussed. The processor 138 communicates with the memory 136 via an address/data bus 248 and the I/O data ports 146 via an address/date bus 249. The processor 138 can be any commercially available or custom microprocessor. The memory 136 is representative of the overall hierarchy of memory devices containing the software and data used to implement the functionality of the data processing system 100. The memory 136 can include, but is not limited to, the following types of devices: cache, ROM, PROM, EPROM, EEPROM, flash memory, SRAM, and DRAM.

As shown in FIG. 2, the memory 136 may include several categories of software and data used in the data processing system 100: an operating system 252; application programs 254; input/output (I/O) device drivers 258; and data 256. As will be appreciated by those of skill in the art, the operating system 252 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 100 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

It will be understood that digital media devices according to some embodiments of the present invention may not include an operating system 252 and/or input/output (I/O) device drivers 258 as discussed above. In some embodiments of the present invention, digital media devices may use software in the device configured to run the operations of the device without departing from the scope of the present invention.

As illustrated in FIG. 2, the data 256 according to some embodiments of the present invention may include digital photographs associated with a first distribution tag 250, digital photographs associated with a second distribution tag 255, a first distribution event tag 260, a second distribution event tag 261 and uncategorized photographs 265. The details with respect to this data will be discussed further below.

Although the data 256 only includes two files for digital photographs 250 and 255, two associated event tags 260 and 261 and a single file of uncategorized photographs 265, embodiments of the present invention are not limited to this configuration. Any number of any of these files may be provided without departing from the scope of the present invention.

As further illustrated in FIG. 2, the application programs 254 may include an acquisition module 221, a tagging module 222, a distribution module 223 and a presentation module 224 according to some embodiments of the present invention. While the present invention is illustrated, for example, with reference to the acquisition module 221, the tagging module 222, the distribution module 223 and the presentation module 224 being application programs in FIG. 2, as will be appreciated by those of skill in the art, other configurations may also be utilized while still benefiting from the teachings of the present invention. For example, the acquisition module 221, the tagging module 222, the distribution module 223 and the presentation module 224 may also be incorporated into the operating system 252 or other such logical division of the data processing system 100. Thus, the present invention should not be construed as limited to the configuration of FIG. 2, but is intended to encompass any configuration capable of carrying out the operations described herein.

Furthermore, while the acquisition module 221, the tagging module 222, the distribution module 223 and the presentation module 224 are illustrated in a single data processing system, as will be appreciated by those of skill in the art, such functionality may be distributed across one or more data processing systems. Thus, the present invention should not be construed as limited to the configuration illustrated in FIGS. 1 through 2, but may be provided by other arrangements and/or divisions of function between data processing systems.

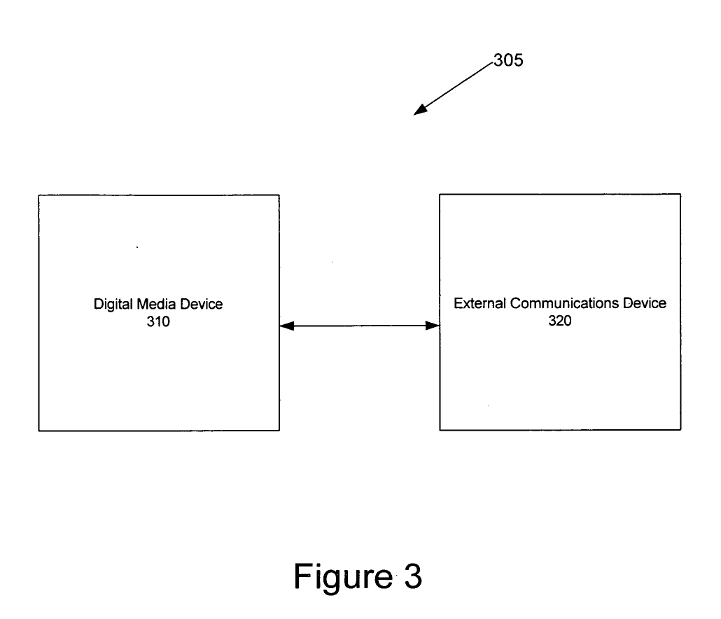

In particular, FIG. 3 illustrates a high level block diagram of systems according to some embodiments of the present invention. As illustrated therein, the system 305 includes a digital media device 310 and an external communications device 320. The digital media device 310 and the external communications device may communication wirelessly, over a wired line, through a network (not shown) or using any other communication method known to those having skill in the art without departing from the scope of the present invention. As discussed above, application programs 254 may not all reside on the same device. For example, in some embodiments of the present invention the acquisition module 221 may be disposed in the digital media device, such as a digital camera, video camera, mobile terminal or the like. Furthermore, the tagging module 222 may be disposed in a separate device, such as the communications device 320, for example, a personal computer, laptop or the like.

In embodiments of the present invention illustrated FIG. 3, the acquisition module 221 may be configured to acquire one or more digital media files. Then, the tagging module 222 may be configured to associate the digital media files with distribution tags according to some embodiments of the present invention during post processing on the external communications device 320. Thus, operations according to some embodiments of the present invention may take place in a single device or multiple devices without departing from the scope of the present invention.

Referring now to FIGS. 1 and 2, a user of the digital media device according to some embodiments of the present invention, may obtain a digital media file using the digital media device. For exemplary purposes only, herein the digital media device will be a digital camera device and the digital media files will be digital photographs. Thus, the acquisition module 221 of the digital camera device may be configured to obtain the photographs taken with the digital camera device by the user. The tagging module 222 may be configured to associate one or more photographs with event tags. As used herein, an “event tag” is a virtual tag that identifies a category associated with the photographs having the event tag. For example, a category may be a soccer game, a ballet recital, a Stanley cup hockey game and the like. The event tag may or may not include the name of the event, for example, “soccer game.” In some embodiments of the present invention, the tag may merely be a marker that marks a start of a series of one or more photographs.

Event tags and the details thereof are discussed in U.S. patent application Ser. No. ______ (Attorney Docket No. 9400-257) entitled METHODS, DEVICES AND COMPUTER PROGRAM PRODUCTS FOR EVENT-BASED MEDIA FILE TAGGING filed concurrently herewith, the content of which is hereby incorporated herein by reference as if set forth in its entirety.

The tagging module 222 may be further configured to associate distribution tags with ones of the acquired digital photographs. The distribution tags may include a distribution history for the digital photographs. The information provided by the distribution tags may include, for example, who the associated digital photograph was distributed to, when the associated digital photograph was distributed, who printed the associated digital photograph, when the associated digital photograph was printed and/or content of the digital photograph.

In some embodiments of the present invention, the content of the digital photograph may be provided by the event tag associated with the digital photograph. As discussed above, the event tag may identify a category for the digital photograph. The information provided by the distribution tag may further include information associated with other photographs associated with a same event tag. For example, there may be five photographs associated with a single event tag and photographs 1 and 5 of the 5 may have been emailed to Grandma on Jun. 2, 2006. The distribution tag may include this information as will be discussed further below.

The distribution module 223 may be configured to alert a recipient of the digital photographs of availability of more digital photographs associated with a same event tag. For example, if only photographs 1 and 5 of 5 photographs associated with the same event tag are sent to Grandma, obviously photographs 2-4 were not sent. According to some embodiments of the present invention, a feature may be enabled by the distribution module 223 that will indicate to Grandma when the photographs are received that there are more pictures related to the two she received. If Grandma chooses to view these photographs, they may be provided to her.

In some embodiments of the present invention, the distribution module 223 may be configured to recreate a previous distribution based on the information provided by the distribution tags. For example, a user may want to send uncle George the same photographs that were sent to Grandma. This information is maintained by the distribution tag and, therefore, the communication sent to Grandma can be recreated. In certain embodiments of the present invention, the user may use the information in the distribution tag to recreate the communication and then the communication may be modified. For example, Uncle George might receive picture 1 and 4 of 5 instead of pictures 1 and 5.

The presentation module configured 224 is configured to organize the digital photographs based on the information provided by the distribution tags. For example, the most printed or most distributed photograph may be presented first so as to allow a user to immediately assess the popularity of the photographs.

Some embodiments of the data 256 portion of the memory 136 will now be discussed with respect to the block diagrams of FIG. 3. As illustrated in FIG. 3, the data 356 includes first and second memory locations 310 and 320 and other memory 330. The first and second memory locations 310 and 320 can be thought of as virtual files or file drawers in which photographs or media having the same event tag, for example, EV#1 or EV#2, are stored. In particular, the first memory location 310 includes three photographs 312, 314 and 316 having the same event tag EV#1. This event tag could be associated with any type of event, for example, a baseball game, a play, a family outing or the like. Similarly, the second memory location 320 includes three photographs 322, 324 and 326 having the same event tag EV#2. Furthermore, other memory 330 is also provided in the data 356, which includes uncategorized photographs 332 and 334, i.e., photographs with no associated event tag. It will be understood that the uncategorized photographs 332 and 334 may at some time in the future be associated with an event tag and moved to the memory location associated with the associated event tag.

As further illustrated in FIG. 3, the photographs 312, 314, 316, 322, 324 and 326 all have an associated distribution tag. In particular, photographs 312, 314 and 316 are associated with a first distribution tag DT#1 and photographs 322, 324 and 326 are associated with a second distribution tag DT#2.

As illustrated, the photographs, for example, photographs 722, 724 and 726, may include a visual indication of the event tag (EV#2) and/or distribution tag (DT#2) associated therewith so as to allow the user to identify the associated event by looking at the photograph. For example, the user may right click on the photograph to obtain the information provided by the event (EV#2) and/or distribution (DT#2) tags. In some embodiments of the present invention, the photographs may also include a visual indication of the total number of photographs associated with the event tag and each individual photograph may include a visual indication of where that particular photograph falls in the sequence of photographs associated with that event tag. For example, as illustrated in FIG. 3, each of the photographs 312, 314 and 316 have an associated ratio 1/3, 2/3 and 3/3, respectively. In other words, there are 3 total photographs associated with the event tag EV#1 and distribution tag DT#1 and photograph 312 is the first of the three, photograph 314 is the second of the three and photograph 316 is the third of the three.

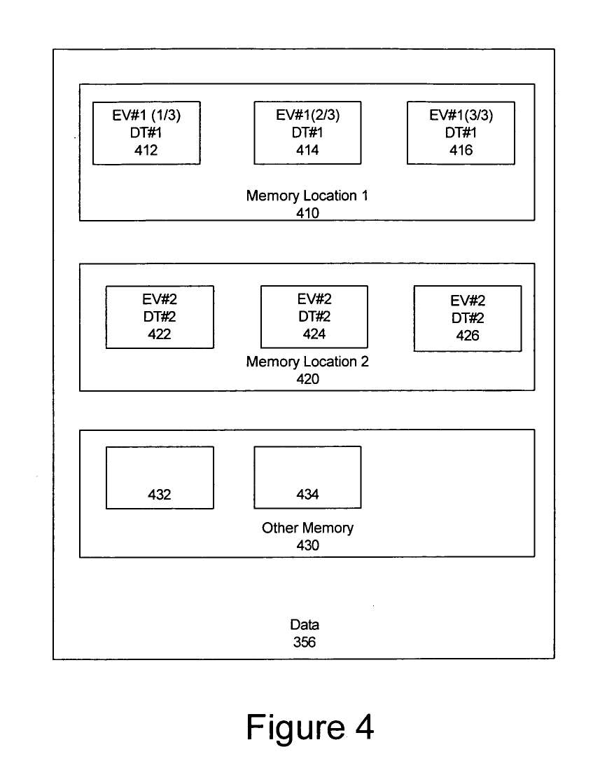

Referring now to FIG. 4, exemplary content of a distribution tag according to some embodiments of the present invention will be discussed. As illustrated in FIG. 4, the distribution tag may provide information on who the photographs were sent to, when the photographs were sent and which particular photographs were actually sent to that individual. In particular, as illustrated in FIG. 4, photographs 1 and 3 of 3 total associated with event tag EV#1 were sent to Grandma on Jun. 10, 2006. Furthermore, photographs 1 and 2 of 3 total associated with event tag EV#1 were sent to Uncle George on Jul. 5, 2006.

In some embodiments of the present invention, the distribution tag may include production information, for example, how many times a photograph has been printed. As illustrated in FIG. 4, photograph 1 has been printed 3 times, photograph 2 has been printed 5 times and photograph 3 has been printed 2 times. In certain embodiments of the present invention, the distribution tag may provide information about which photographs have been emailed the most, which photographs have been printed the most and the like. In particular, as illustrated in FIG. 4, photograph 1 of 3 has been mailed the most and photograph 2 of 3 has been printed the most.

It will be understood that in order for the print tracking to take place across all recipients, the distribution tagging and printing request functions should generally be resident in the same system, for example, an on line photo web service. If not, it would be difficult to detect if the recipient printed the picture locally.

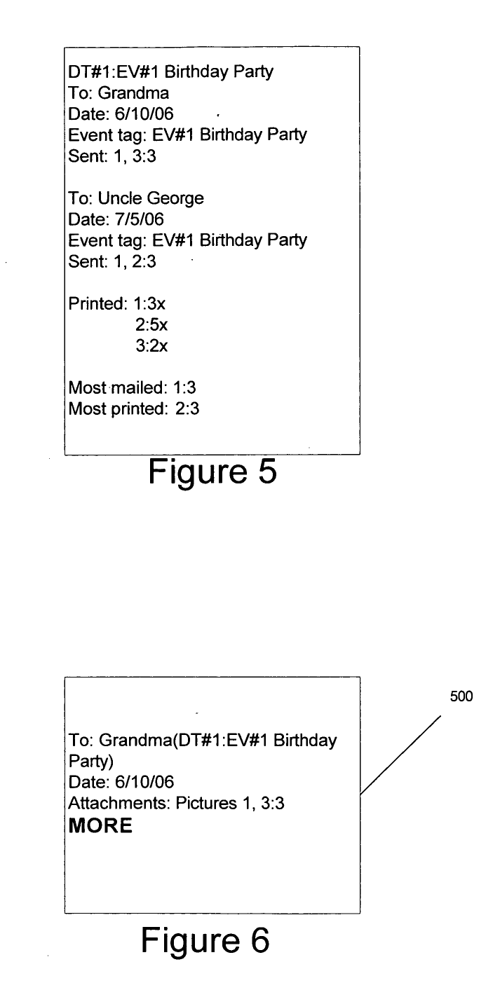

Referring now to FIG. 5, an exemplary communication of digital photographs according to some embodiments of the present invention will be discussed. As illustrated in FIG. 5, Grandma may receive an email 500 including FIGS. 1 and 3 of 3 total figures associated with an event tag EV# 1 on Jun. 10, 2006. As discussed above, some embodiments of the present invention may be configured to alert a recipient of the digital photographs, Grandma, of availability of more digital photographs associated with a same event tag, EV#1. For example, only photographs 1 and 3 of 3 photographs associated with event tag EV#1 were sent to Grandma, thus photograph 2 was not sent. As illustrated in FIG. 5, the person who sent the photograph has enabled a MORE function, which may allow Grandma to obtain the other pictures related to the two she received. If Grandma chooses to view these photographs, they may be provided to her. In some embodiments of the present invention, Grandma may click on MORE and this will link her to the whole album of photographs associated with EV#1.

Furthermore, in some embodiments of the present invention, the email 500 may include voting buttons, which may allow the recipient of the email 500 to select which of the photographs he or she liked the best. This information may be used to determine which photographs to send to other people according to some embodiments of the present invention.

In some embodiments of the present invention, the photographs and/or media files may be sent for business purposes. In these embodiments of the present invention, if the use would like to see more of the photographs and/or media files he or she may be charged to do so.

Furthermore, although embodiments of the present invention are discussed primarily herein with respect to sending and/or receiving digital photographs in a personal capacity, i.e. to Grandma or family members, embodiments of the present invention are not limited to this configuration. For example, photographs and/or media files may be sent and tracked according to some embodiments of the present invention for any reason. For example, an architect may send out portions of his portfolio to firms where he or she is trying to get a job. The distribution tags according to some embodiments of the present invention may enable the architect to keep track of which firms were sent which portions of his or her portfolio as discussed herein.

In some embodiments of the present invention, the distribution/printed/alert tagging may be implemented using XML, as illustrated below.

<Event 1>
<Picture 1>
<recipients> Mom=Jane.Smith@bellsouth.net, notify=0, show=1; Uncle
Pete=Peter.Rabbit@wonderland.com, notify=1, show=0 </recipients>
<prints> Count=1 </prints>
</Picture 1>
<Picture 2>
<recipients>Mom=Jane.Smith@bellsouth.net, notify=0</recipients>
<prints> Mom=1 </prints>
</Picture 2>
<Event 1>

According to some embodiments of the present invention a media distribution and management program may interpret these tags and take action accordingly when a new media file was added to the event (see notify tag), or is printed. Thus, according to some embodiments of the present invention, an owner of, for example, a picture album, could quickly view what has been sent to whom by requesting a list of pictures sent by name of recipient. Although not illustrated in the example set out above, a date tag may also be included on the distribution. The show tag present in the example set out above may indicate whether or not the recipient should be told there re other pictures in the event that they could request.

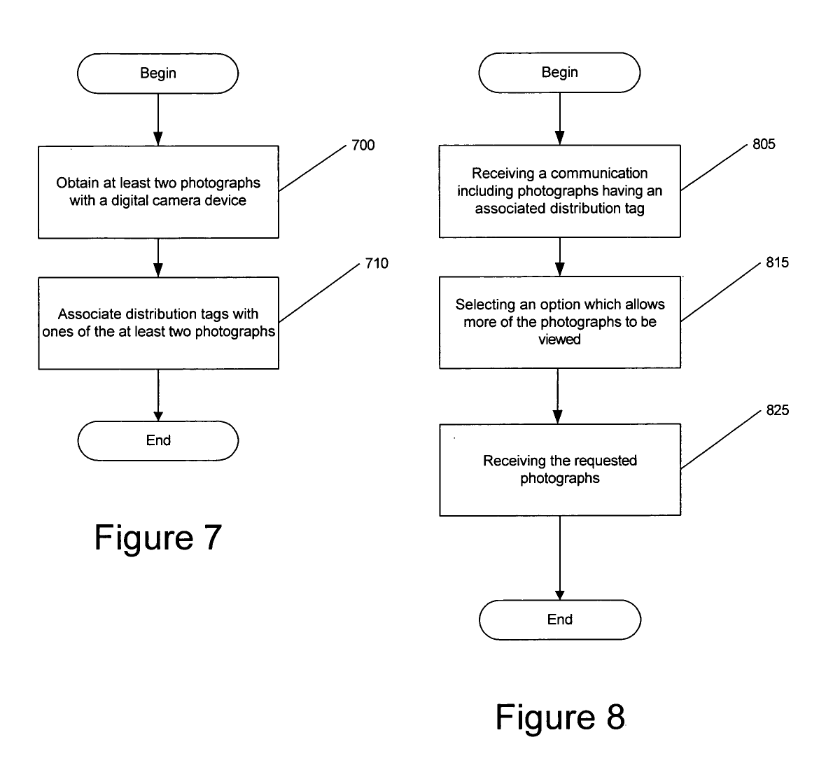

Operations according to some embodiments of the present invention for tracking distribution of digital photographs will now be discussed with respect to the flowcharts of FIGS. 6 and 7. Referring first to the flowchart of FIG. 6, operations begin at block 600 by obtaining two or more digital photographs with a digital camera device. In other words, a user of the digital camera device will take two or more photographs. Distribution tags are associated with ones of the two or more digital photographs (block 610). As discussed above, the distribution tags include a distribution history for the two or more digital photographs. Thus, the distribution tag may include information with respect to who the associated digital photograph was distributed to, when the associated digital photograph was distributed, who printed the associated digital photograph, when the associated digital photograph was printed and/or content of the digital photograph and the like.

In some embodiments of the present invention, the content of the digital photograph may be provided by an event tag associated with the digital photograph. The event tag may identify a category for the photograph, for example, soccer game or ballet recital. In certain embodiments of the present invention, the information provided by the distribution tag may include information associated with other photographs associated with a same event tag. For example, 2 out of 5 photographs associated with the same event tag were sent to Grandma on Jun. 10, 2006.

In some embodiments of the present invention, the digital photographs may be organized based on the information provided by the distribution tags. For example, the photograph that has been shared (emailed) or printed the most may be presented first. Furthermore, a previous distribution may be recreated based on the information provided by the distribution tags. For example, the same photographs sent to Grandma may be sent to Uncle George. In some embodiments, the photographs sent to Grandma may be modified and then sent to Uncle George.

Operations according to further embodiments of the present invention will now be discussed with respect to the flowchart of FIG. 7. Operations begin at block 705 by receiving a communication including photographs having a distribution tag in accordance with some embodiments of the present invention. For example, the email 500 of FIG. 5 discussed above. The recipient of the email/communication may be alerted that more digital photographs associated with a same event tag are available and may select an option that allows the recipient to view more of the photographs (block 715). For example, the recipient may select a link entitled “MORE,” which will allow the user to view or receive the associated photographs (block 725). For example, the link may bring up a website where the recipient can view the photographs.

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A method for tracking distribution of digital photographs, comprising:
obtaining at least two digital photographs with a digital camera device; and
associating distribution tags with ones of the at least two digital photographs, the distribution tags including a distribution history for the at least two digital photographs.

2. The method of claim 1, wherein information provided by the distribution tags comprises who the associated digital photograph was distributed to, when the associated digital photograph was distributed, who printed the associated digital photograph, when the associated digital photograph was printed and/or content of the digital photograph.

3. The method of claim 2, wherein the content of the digital photograph is provided by an event tag associated with the digital photograph, the event tag identifying a category for the photograph.

4. The method of claim 3, wherein the information provided by the distribution tag further comprises information associated with other photographs associated with a same event tag.

5. The method of claim 2, further comprising alerting a recipient of the at least two digital photographs of availability of more digital photographs associated with a same event tag.

6. The method of claim 2, further comprising organizing the at least two digital photographs based on the information provided by the distribution tags.

7. The method of claim 2, further comprising recreating a previous distribution based on the information provided by the distribution tags.

8. A system for tracking distribution of media files, comprising:
an acquisition module configured to obtain media files; and
a tagging module configured to associate distribution tags with ones of the media files, the distribution tags including a distribution history for the media files.

9. The system of claim 8, wherein the acquisition module and the tagging module are contained within a single device.

10. The system of claim 8, wherein the acquisition module and the tagging module are disposed within multiple devices.

11. The system of claim 8, wherein information provided by the distribution tags comprises who the associated media file was distributed to, when the associated media file was distributed, who printed the associated media file, when the associated media file was printed and/or content of the media file.

12. The system of claim 11, wherein the content of the media file is provided by an event tag associated with the media file, the event tag identifying a category for the media file.

13. The system of claim 12, wherein the information provided by the distribution tag further comprises information associated with other media files associated with a same event tag.

14. The system of claim 12, further comprising a distribution module configured to alert a recipient of the media files of availability of more media files associated with a same event tag.

15. The system of claim 12, further comprising a presentation module configured to organize the at least two media files based on the information provided by the distribution tags.

16. The system of claim 12, further comprising a distribution module configured to recreate a previous distribution based on the information provided by the distribution tags.

17. A computer program product for tracking distribution of digital photographs, the computer program product comprising:
computer readable storage medium having computer readable program code embodied in said medium, the computer readable program code comprising:
computer readable program code configured to obtain at least two digital photographs with a digital camera device; and
computer readable program code configured to associate distribution tags with ones of the at least two digital photographs on the digital camera device, the distribution tags including a distribution history for the at least two digital photographs.

18. The computer program product of claim 17, wherein information provided by the distribution tags comprises who the associated digital photograph was distributed to, when the associated digital photograph was distributed, who printed the associated digital photograph, when the associated digital photograph was printed and/or content of the digital photograph.

19. The computer program product of claim 18, wherein the content of the digital photograph is provided by an event tag associated with the digital photograph, the event tag identifying a category for the photograph.

20. The computer program product of claim 19, wherein the information provided by the distribution tag further comprises information associated with other photographs associated with a same event tag.
